(19) United States
(12) Patent Application Publication
(10) Pub. No.: US 2025/0179658 A1
(43) Pub. Date: Jun. 5, 2025

(54) METHOD OF PRODUCING A METAL BOROHYDRIDE OR BORIC ACID FROM METAL METABORATE

(71) Applicant: H2FUEL WORKS B.V., Voorschoten (NL)

(72) Inventors: Lars Jacob Cornelis VAN DER ZEE, Weesp (NL); Kaj Melvin VAN VLIET, Amsterdam (NL); Jacob Christiaan SLOOTWEG, Hilversum (NL)

(21) Appl. No.: 18/842,161

(22) PCT Filed: Mar. 3, 2023
(86) PCT No.: PCT/NL2023/050104

§ 371 Date: Aug. 28, 2024

(30) Foreign Application Priority Data
Mar. 3, 2022 (NL) 2031153

(51) Int. Cl. C25B 1/16; C25B 1/04; C25B 1/20; C25B 1/22; C25B 9/19; C25B 11/052; C25B 11/063; C25B 11/081; C25C 3/02

(52) U.S. Cl. CPC C25B 1/16; C25B 1/04; C25B 1/20; C25B 1/22; C25B 9/19; C25B 11/052; C25B 11/063; C25B 11/081; C25C 3/02

(57) ABSTRACT

In a method of producing metal borohydride, M(BH₄)ₙ, from metal metaborate, M(BO₂)ₙ, in which M is a metal, such as a metallic metal, an alkali metal, an alkaline earth metal, a transition metal or a chemical compound behaving as a metal, and n is a valence value of the metal, metal borohydride is formed through a reaction of metal hydride, MHₙ, with trimethyl borate, B(OMe)₃, and metal trimethyl borate is formed through a reaction of boric acid, H₃BO₃, with methanol, MeOH, under removal of water, H₂O. An electrochemical cell is used for the conversion of metal metaborate and water, H₂O, to boric acid, in the electrochemical cell. The electrochemical cell has an anodic half-cell and a cathodic half-cell separated by a cation exchange membrane, and a solvent and water is provided to both the anodic half-cell and the cathodic half-cell. Metal metaborate is provided to the anodic half-cell, where acid ions, H⁺, and electrons, e⁻, are generated at the anode from electrolysis of water, and H reacts with metal metaborate and water. The cation exchange membrane passes metal ions, Mⁿ⁺, from the anodic half-cell to the cathodic half-cell, and metal hydroxide, M(OH)ₙ, is formed in the cathodic half-cell.

### FIELD OF THE INVENTION

The invention relation to a method of producing metal borohydride, M(BH₄)ₙ, from metal metaborate or one of its hydrates, M(BO₂)ₙ, as a starting material, in which M is a metal, such as a metallic metal, an alkali metal, an earth alkali metal, a transition metal or a chemical compound behaving as a metal, and n is a valence value of the metal. The metal borohydride is formed through a reaction of metal hydride, MHₙ, with trimethyl borate, B(OMe)₃, and trimethyl borate is formed through a reaction of boric acid, H₃BO₃, with methanol, MeOH, under removal of water, H₂O.

### BACKGROUND OF THE INVENTION

Sodium borohydride, NaBH₄, is widely used in industry. It is used as a reducing agent for the reduction of, among others, aldehydes and ketones, and is produced in tonnage quantities. A particular important industrial reaction of NaBH₄ is the reduction of sulfur dioxide or sodium hydrogen sulfite to sodium dithionite as shown by the reaction formula below

NaBH₄+8NaOH+8SO₂→Na₂S₂O₄+NaBO₂+6H₂O.
Sodium dithionite is a bleaching agent used during paper production. This process currently forms a very large application of NaBH₄.

Another application that is being explored, is a metal borohydride, for instance, sodium borohydride, NaBH₄, as hydrogen storage medium. Hydrogen gas, H₂, is often put forward as a crucial energy carrier in the renewable energy transition, as it has a high energy capacity of 122 MJ/kg. Nonetheless, hydrogen gas has a low density and thus low volumetric energy capacity. At room temperature, 1 kg of H₂ occupies a volume of 11 m³. Consequently, H₂ storage is a significant barrier for its application as an energy carrier. Sodium borohydride, NaBH₄, can act as a solid storage medium, releasing four equivalents of H₂ upon its hydrolysis with water or an alcohol as shown by the below reaction formula.

NaBH₄+2H₂O→NaBO₂+4H₂.
Other metal borohydrides, M(BH₄)ₙ, in which M represents a metal and n a valence value of the metal, can be employed for the same purpose as well, such as LiBH₄, KBH₄, Mg(BH₄)₂, Al(BH₄)₃, etc. Generally, the metal, M, can be a metallic metal, like magnesium, Mg, or aluminium, Al; an alkali or alkaline earth metal, like sodium, Na, potassium, K, or calcium, Ca; a transition metal or a chemical compound behaving as a metal. The reaction formula for a general metal borohydride to produce hydrogen gas is as follows

M(BH₄)ₙ+2nH₂O→M(BO₂)ₙ+4nH₂.

A disadvantage of the use of borohydrides, BH₄⁻, such as sodium borohydride, NaBH₄, in every application is the waste product metaborate, such as sodium metaborate, NaBO₂, or a metal metaborate in general, that is formed, as currently there are no major applications for metaborates, such as sodium metaborate, NaBO₂.

Currently, NaBH₄ is produced industrially via two main processes, one of these being the Bayer process (S. S. Muir, Sodium Borohydride Production and Utilisation for Improved Hydrogen Storage, The University of Queensland, Australia, 2013). In this process borax, Na₂B₄O₇, a naturally occurring mineral, is used as a boron source and silica, SiO₂, and metallic sodium are added. The overall reaction is

Na₂B₄O₇+7 SiO₂+16 Na+8H₂→4 NaBH₄+7 NaSiO₃.

The other process used in industry for the production of sodium borohydride is the Brown-Schlesinger process as shown in FIG. 1, in which borax is also used as the boron source (S. S. Muir, Sodium Borohydride Production and Utilisation for Improved Hydrogen Storage, The University of Queensland, Australia, 2013). The first step is the production of hydrogen gas from methane. In step 3 the hydrogen is combined with metallic sodium, obtained from the electrolysis of sodium chloride in step 2, to yield sodium hydride, NaH. At the same time, borax is converted into boric acid, H₃BO₃, with sulfuric acid, H₂SO₄, in step 4. In step 5, trimethyl borate, B(OMe)₃, is subsequently formed by the addition of methanol, MeOH, and the removal of water, H₂O. In the final step, step 6, the sodium hydride and trimethyl borate are reacted to give sodium borohydride, NaBH₄. Sodium methoxide, NaOMe, formed as a byproduct in step 6 is recycled back to methanol with the help of water.

Both processes currently used to produce sodium borohydride, NaBH₄, make use of fossil borax that is obtained through mining. A disadvantage of the use of NaBH₄ in widely used applications is the waste product sodium metaborate, NaBO₂, or a metal metaborate in general, that is formed, as currently there are no major applications for NaBO₂. Another disadvantage concerns waste produced during the synthesis of borohydrides, for instance, sodium sulfate due to the use of sulfuric acid, H₂SO₄, and chlorine gas, Cl₂, in the case of the Brown-Schlesinger process.

### SUMMARY OF THE INVENTION

It is an objective of the invention to provide a process that uses metal metaborate or a hydrate thereof, such as, for instance, sodium metaborate, as a boron source to produce metal borohydride, such as, for instance, sodium borohydride.

It is another or alternative objective of the invention to provide a circular process for producing metal borohydride, such as, for instance, sodium borohydride.

It is yet another or alternative objective of the invention to provide a process for producing boric acid from metal metaborate, such as, for instance, sodium metaborate, which could further be used, for instance, to produce metal borohydride.

It is yet another or alternative objective of the invention to provide a clean waste-free process for producing boric acid, for instance, for further use to produce metal borohydride.

It is yet another or alternative objective of the invention to provide a clean waste-free circular process for chemically storing renewable energy, especially renewable electricity for use at a future moment and/or at another location.

In an aspect the invention provides for a method of producing metal borohydride, M(BH₄)ₙ, from metal metaborate, M(BO₂)ₙ, or one of its hydrates, M(BO₂)ₙ·xH₂O, as a starting material, in which M is a metal, such as a metallic metal, an alkali metal, an alkaline earth metal, a transition metal or a chemical compound behaving as a metal, n is a valence value of the metal, and x is a number of water molecules associated with the metal metaborate in a respective hydrate, metal borohydride is formed through a reaction of metal hydride, MHₙ, with trimethyl borate, B(OMe)₃, and trimethyl borate is formed through a reaction of boric acid, H₃BO₃, with methanol, MeOH, under removal of water, H₂O,
wherein an electrochemical cell (100) is used for the conversion of metal metaborate and water, H₂O, to boric acid, in the electrochemical cell according to, at least substantially, an overall reaction according to the reaction formula

4M(BO₂)ₙ+10nH₂O→4nH₃BO₃+4M(OH)ₙ+nO₂+2nH₂,
wherein the electrochemical cell has an anodic half-cell with an anode and, at least substantially, water as a liquid in the anodic half-cell, a cathodic half-cell with a cathode and, at least substantially, only water as a liquid in the cathodic half-cell, and a cation exchange membrane separating the anodic half-cell and the cathodic half-cell,
wherein a positive pole and a negative pole of an electric potential source are connected to the anode and the cathode, respectively,
wherein, at least substantially, metal metaborate is provided to the water in the anodic half-cell to provide a solution of metal metaborate in water in the anodic half-cell, and, in the anodic half-cell, acid ions, H⁺, and electrons, e⁻, are generated at the anode from electrolysis of water for H⁺ to react with metal metaborate and water, according to the reaction formulas

2nH₂O→4nH⁺+nO₂+4n e⁻, and

4M(BO₂)ₙ+4nH⁺+4nH₂O→4nH₃BO₃+4Mⁿ⁺,
to have, at least substantially, an overall reaction in the anodic half-cell according to the reaction formula

4M(BO₂)ₙ+6nH₂O→4nH₃BO₃+nO₂+4Mⁿ⁺+4n e⁻,
wherein the cation exchange membrane passes metal ions, Mⁿ⁺, from the anodic half-cell to the cathodic half-cell, and
wherein, in the cathodic half-cell, hydroxide ions, OH⁻, are generated at the cathode from water and electrons, e⁻, from the cathode, to form metal hydroxide, M(OH)ₙ, from metal ions and water, according to the reaction formulas

4nH₂O+4n e⁻→2nH₂+4nOH⁻, and

4Mⁿ⁺+4nOH⁻→4M(OH)ₙ,
to have, at least substantially, an overall reaction in the cathodic half-cell according to the reaction formula

4Mⁿ⁺+4nH₂O+4n e⁻→4M(OH)ₙ+2nH₂.

The reactions as defined by reaction formulas are intended to be understood as the primary reactions to occur. The phrase ‘at least substantially’ can be understood as ‘primarily’. These reactions should be understood as to occur at least substantially in that some other reactions could take place as minority reactions as well. The main reactions occurring are the ones as specified above. Additional solvents and/or materials could be employed as well, but only so as to not obstruct the primary reactions to occur according to the invention.

In an embodiment, metal hydride is produced from conversion of metal hydroxide in an electrochemical cell to metallic metal and subsequent reaction with hydrogen, H₂.

In an embodiment, the electrochemical cell is a Castner cell.

In an embodiment, the hydrogen for the reaction with metallic metal is produced by electrolysis of water.

In an embodiment, hydrogen produced in the cathodic half-cell of the electrochemical cell for the conversion of metal metaborate and water, H₂O, to boric acid is used for the reaction with metallic metal.

In an aspect the invention provides for a method of producing boric acid, H₃BO₃, from a metal metaborate, M(BO₂)ₙ, or one of its hydrates, M(BO₂)ₙ·xH₂O, as a starting material, in which M is a metal, such as a metallic metal, an alkali metal, an alkaline earth metal, or a transition metal, or a chemical compound acting as a metal, n is a valence value of the metal, and x is a number of water molecules associated with the metal metaborate in a respective hydrate,
wherein an electrochemical cell (100) is used for the conversion of metal metaborate and water, H₂O, to boric acid, in the electrochemical cell according to, at least substantially, an overall reaction according to the reaction formula

4M(BO₂)ₙ+10nH₂O→4nH₃BO₃+4M(OH)ₙ+nO₂+2nH₂,
wherein the electrochemical cell has an anodic half-cell with an anode and, at least substantially, water as a liquid in the anodic half-cell, a cathodic half-cell with a cathode and, at least substantially, only water as a liquid in the cathodic half-cell, and a cation exchange membrane separating the anodic half-cell and the cathodic half-cell,
wherein a positive pole and a negative pole of an electric potential source are connected to the anode and the cathode, respectively,
wherein, at least substantially, metal metaborate is provided to the water in the anodic half-cell to provide a solution of metal metaborate in water in the anodic half-cell, and, in the anodic half-cell, acid ions, H⁺, and electrons, e⁻, are generated at the anode from electrolysis of water for H⁺ to react with metal metaborate and water, according to the reaction formulas

2nH₂O→4nH⁺+nO₂+4n e⁻, and

4M(BO₂)ₙ+4nH⁺+4nH₂O→4nH₃BO₃+4Mⁿ⁺,
to have, at least substantially, an overall reaction in the anodic half-cell according to the reaction formula

4M(BO₂)ₙ+6nH₂O→4nH₃BO₃+nO₂+4Mⁿ⁺+4n e⁻,
wherein the cation exchange membrane passes metal ions, Mⁿ⁺, from the anodic half-cell to the cathodic half-cell, and
wherein, in the cathodic half-cell, hydroxide ions, OH⁻, are generated at the cathode from water and electrons, e⁻, from the cathode, to form metal hydroxide, M(OH)ₙ, from metal ions and water, according to the reaction formulas

4nH₂O+4n e⁻→2nH₂+4nOH⁻, and

4Mⁿ⁺+4nOH⁻→4M(OH)ₙ,
to have, at least substantially, an overall reaction in the cathodic half-cell according to the reaction formula

4Mⁿ⁺+4nH₂O+4n e⁻→4M(OH)ₙ+2nH₂.

The reactions as defined by reaction formulas are intended to be understood as the primary reactions to occur. The phrase ‘at least substantially’ can be understood as ‘primarily’. These reactions should be understood as to occur at least substantially in that some other reactions could take place as minority reactions as well. The main reactions occurring are the ones as specified above. Additional solvents and/or materials could be employed as well, but only so as to not obstruct the primary reactions to occur according to the invention.

In an embodiment, the metal, M, is selected from at least one of lithium, Li; sodium, Na; potassium, K; magnesium, Mg; calcium, Ca; and aluminum, Al.

In an embodiment, the concentration of metal metaborate in water is in the range of 0.2 M to 8 M.

In an embodiment, a metal hydroxide is added to at least one of the anodic half-cell and the cathodic half-cell for enhanced electrical conductivity.

In an embodiment, the concentration of metal hydroxide in water is in the range of 0 M to 3 M.

In an embodiment, the electric potential source is provided by, for instance, a potentiostat, galvanostat or battery.

In an embodiment, an electric potential provided by the electric potential source between the anode and the cathode is in the range of 2V to 12V.

In an embodiment, a material of the anode is selected from at least one of stainless steel, mild steel, nickel, Raney Nickel or Raney Nickel contaminated with small amounts of other metals.

In an embodiment, a material of the cathode is selected from at least one of DSA platinized titanium and any other type of platinum-based material.

In an embodiment, the electrochemical cell for the conversion of metal metaborate and water, H₂O, to boric acid is an electrochemical flow cell or a batch electrochemical cell.

In an embodiment, the boric acid provided by the electrochemical cell is available as a solution of boric acid dissolved in water, and the solution of boric acid dissolved in water is at least one of cooled and concentrated to obtain boric acid by precipitation.

### BRIEF DESCRIPTION OF THE DRAWINGS

Further features and advantages of the invention will become apparent from the description of the invention by way of non-limiting and non-exclusive embodiments. These embodiments are not to be construed as limiting the scope of protection. The person skilled in the art will realize that other alternatives and equivalent embodiments of the invention can be conceived and reduced to practice without departing from the scope of the present invention. Embodiments of the invention will be described with reference to the accompanying drawings, in which like or same reference symbols denote like, same or corresponding parts, and in which

FIG. 1 shows a schematic overview of the prior art Brown-Schlesinger process for the production of sodium borohydride;

FIG. 2 shows a schematic view of an electrochemical cell for the production of boric acid from a metal metaborate according to an embodiment of the invention; and

FIG. 3 shows a schematic overview of a circular process for the production of sodium borohydride according to an embodiment of the invention.

### DETAILED DESCRIPTION OF EMBODIMENTS

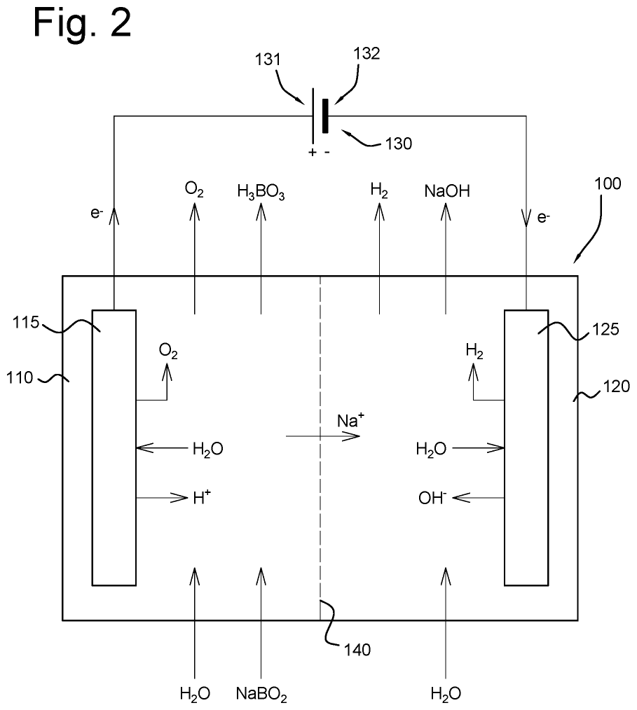

FIG. 2 shows a schematic overview of an electrochemical cell 100 as employed in a step for converting sodium metaborate, NaBO₂, into boric acid, H₃BO₃, according to an embodiment of the invention. The electrochemical cell 100 is embodied as an electrochemical flow cell in the embodiment shown. In another embodiment, for example, the electrochemical cell may be a batch electrochemical cell. The electrochemical flow cell 100 has an anodic half-cell 110 with an anode 115 and a cathodic half-cell 120 with a cathode 125. The anode 115 and cathode 125 are connected by an electric potential source 130 having its positive pole 131 connected to the anode 115 and its negative pole 132 connected to the cathode 125 to allow passing electrons, e⁻, from the anode 115 to the cathode 125. The anodic half-cell 110 and the cathodic half-cell 120 are separated by a cation exchange membrane 140 for passing cations form one half-cell to the other one. Water, H₂O, is provided in flow to both the anodic half-cell 110 and the cathodic half-cell 120. The water acts both as a solvent and as a reactant in the various reactions taken place. Water is primarily used in both half-cells, but one or more other solvents may additionally be employed as well.

Together with water, H₂O, sodium metaborate, NaBO₂, is provided to the anodic half-cell as well. Actually, the sodium metaborate is provided as a solution in water, which acts as the electrolyte in the anodic half-cell 110. The electrical potential source 130 provides a sufficient potential over the anode 115 and cathode 125 to have an electrolysis reaction of water in the anodic half-cell to take place according to the reaction formula

2H₂O→4H⁺+O₂+4e⁻,
which provides in situ acid from the water of the anodic electrolyte solution. The acid together with water subsequently converts sodium metaborate, NaBO₂, to boric acid, H₃BO₃, according to the reaction formula

4NaBO₂+4H⁺+4H₂O→4H₃BO₃+4Na⁺.
The above two reaction formulas are a rather formal approach to the reaction mechanism. The latter reaction is an equilibrium between metaborate, tetraborate and boric acid, and possibly other intermediates as well. Actually, the reactions take place at the same time in the anodic half-cell 110, which provides for an overall reaction in the anodic half-cell as follows

4NaBO₂+6H₂O→4H₃BO₃+O₂+4N⁺+4e⁻.
The sodium metaborate is provided at a selected concentration in solution in water as anodic electrolyte to the anodic half-cell 110, while boric acid in solution in water leaves the anodic half-cell together with oxygen, O₂, gas. In the electrochemical flow cell 100 shown, a flow of water is provided, which charges the anodic half-cell 110 with sodium metaborate and discharges boric acid and oxygen from the anodic half-cell 110. In an embodiment, the concentration of the sodium metaborate in water for the anodic half-cell can be in the range of 0.2 M (mol/dm³) to 8 M. The concentration used should be chosen based on, for instance, solubility of starting materials, intermediates and products at the operating temperature.

Water is provided in flow to the cathodic half-cell 120 of the electrochemical flow cell 100 as well (preferably, a solution of sodium hydroxide in water is provided). In the cathodic half-cell 120, water is reduced at the cathode 125 in the hydrogen-evolution reaction, whereby hydrogen, H₂, gas and hydroxide ions, OH⁻, are formed according to the reaction formula

4H₂O+4e⁻→2H₂+4OH⁻
The anodic half-cell 110 and the cathodic half-cell 120 are separated by a cation exchange membrane 140, which allows the sodium ions, Na*, that have formed in the anodic half-cell 110 to pass from the anodic half-cell to the cathodic half-cell. In the cathodic half-cell the sodium ions and the hydroxide ions provide a sodium hydroxide solution in the water, which may be represented by the following reaction formula

4Na⁺+4OH⁻→4NaOH.
The above two reaction formulas are a rather formal approach to the reaction mechanism. Actually, both reactions take place at the same time in the cathodic half-cell 120, which provides for an overall reaction in the cathodic half-cell as follows

4Na⁺+4H₂O+4e⁻→4NaOH+2H₂
The flow of water provided to and discharged from the cathodic half-cell 120 of the electrochemical flow cell 100 discharges the sodium hydroxide in solution and hydrogen gas formed from the cathodic half-cell 120.

The cation exchange membrane 140 should be permeable for the transfer of sodium ions, Na⁺, from anodic electrolyte solution to cathodic electrolyte solution. Suitable cation exchange membranes for this purpose are, for example, Nafion™ 324, 424 or 551 membranes, which are fluorinated polymeric membranes, or NaSICON (sodium, Na, Super Ionic CONductor) membranes.

The reactions in both the anodic half-cell 110 and the cathodic half-cell 120 all take place at the same time and balance to provide an overall reaction in the electrochemical cell 100 as follows

4NaBO₂+10H₂O→4H₃BO₃+4NaOH+O₂+2H₂.

It is generally advantageous to heat the electrochemical cell to, for instance, 80° C. for operation thereof. The actual operation temperature selected will be based on the concentrations and solubility of the materials in solution (reactants, intermediates and products), characteristics of the cation exchange membrane employed, flow rate of the electrolyte solutions, etcetera.

Preferably, a concentration of sodium hydroxide is provided in the ingoing water for the cathodic half-cell 120 to provide a sufficient conductivity to the cathodic electrolyte solution of the electrochemical cell 100. In an embodiment, the concentration of sodium hydroxide in water for the cathodic half-cell can be in the range of 0 M to 3 M. A concentration at the lower end provides a more favorable concentration difference over the membrane, whereas a higher concentration provides a higher conductivity and a lower required electrical potential. The ingoing anodic electrolyte solution for the anodic half-cell 110 can be heated to provide sufficient solubility for the sodium metaborate, intermediates and products in the anodic electrolyte solution.

The outgoing anodic flow can be cooled to have the boric acid crystalize out of (precipitation) the solution discharged from the anodic half-cell 110. The various conditions, such as flow rates and temperatures, can be selected such that most boric acid is crystalized out of the flow discharged from the anodic half-cell, after which the flow is cycled back to the ingoing end of the anodic half-cell with additional sodium metaborate added to any sodium metaborate that may have remained in the flow discharged from the anodic half-cell. The solubility of any intermediates, such as, for instance, tetraborate, should be taken into account as well. Solubilities of sodium metaborate and boric acid are as follows at different temperatures, which are to be taken into account for temperatures selected.

TABLE 1
Solubility of sodium metaborate and
boric acid in water at different temperatures

| solubility in | Temperature (° C.) | | | |
|---|---|---|---|---|
| 100 mL water | 0 | 20 | 80 | 100 |
| sodium | 14.10 g | 20.22 g | 45.80 g | 55.60 g |
| metaborate | 0.214 mol | 0.307 mol | 0.696 mol | 0.845 mol |
| boric acid | 1.52 g | 2.62 g | 10.73 g | 15.50 g |
| | 0.025 mol | 0.042 mol | 0.174 mol | 0.251 mol |

Data from Blasdale, W. C.; Slansky, C. M. J. Am. Chem. Soc. 1939, 61 (4), 917-920.

A same type of considerations apply to the flow discharged from and ingoing to the cathodic half-cell 120. Sodium hydroxide formed in the cathodic half-cell is to be removed from the flow, but some may remain to have sufficient conductivity in the electrochemical cell 100 when the flow is cycled back to the cathodic half-cell 120.

Additional solvents to the water in the half-cells may be employed as well, and more than one solvent might be used. Additional electrolytes and soluable materials, such as a salt, can be added to one or both of the half-cells for enhanced electrical conductivity or other considerations. However, such additional solvents and materials should not obstruct the primary reactions as described. They should be additional to enhance the primary reactions.

The electric potential source 130 is embodied as a so-called potentiostat for generating a cell voltage between the anode 115 and the cathode 125 in the range of 2V to 12V. In another embodiment, the electric potential source is a galvanostat. Theoretically, a minimum voltage of 1.23V is required, which will be higher in practice due to an over-potential at the electrodes and resistance of the electrolyte solution. A distance between the anode and cathode can be selected in dependence of, for instance, flow rates and concentrations used. The anode and the cathode can be made of various suitable materials, such as, for example, stainless steel, mild steel, nickel or Raney Nickel (a porous type of nickel metal, which may possibly be contaminated with small amounts of other metals) for the anode, and such as, for example, DSA platinized titanium or any other type of platinum-based material for the cathode.

The production of boric acid and the respective reactions in the electrochemical cell for the production of boric acid have been described above with sodium. However, other metals, M, can be used as well in addition to or to replace the sodium, Na, in the various chemical compounds used. A metallic metal such as, for example, magnesium, Mg, or aluminum, Al; an alkali or alkaline earth metal such as, for example, lithium, Li, calcium, Ca, and potassium, K; a transition metal; or a chemical compound behaving as a metal can be used as the metal, M, in the various reactions and chemical compounds metal borohydride, M(BH₄)ₙ, metal metaborate, M(BO₂)ₙ, and metal hydroxide, M(OH)ₙ, disclosed above, in which n is a valance value of the metal, M. The exchange membrane should be selected in accordance with the cation of the selected material. The overall reaction in the electrochemical cell would then be written as

4M(BO₂)ₙ+10nH₂O→4nH₃BO₃+4M(OH)ₙ+nO₂+2nH₂,
while the reaction formulas in the anodic half-cell would be written as

2nH₂O→4nH⁺+nO₂+4n e⁻, and

4M(BO₂)ₙ+4nH⁺+4nH₂O→4nH₃BO₃+4Mⁿ⁺,
to have an overall reaction in the anodic half-cell according to the reaction formula

4M(BO₂)ₙ+6nH₂O→4nH₃BO₃+nO₂+4 Mⁿ⁺+4n e⁻,
and the reaction formulas in the cathodic half-cell would be written as

4nH₂O+4n e⁻→2nH₂+4nOH⁻, and

4Mⁿ⁺+4nOH→4M(OH)ₙ,
to have an overall reaction in the cathodic half-cell according to the reaction formula

4Mⁿ⁺+4n H₂O+4n e⁻→4M(OH)ₙ+2n H₂.

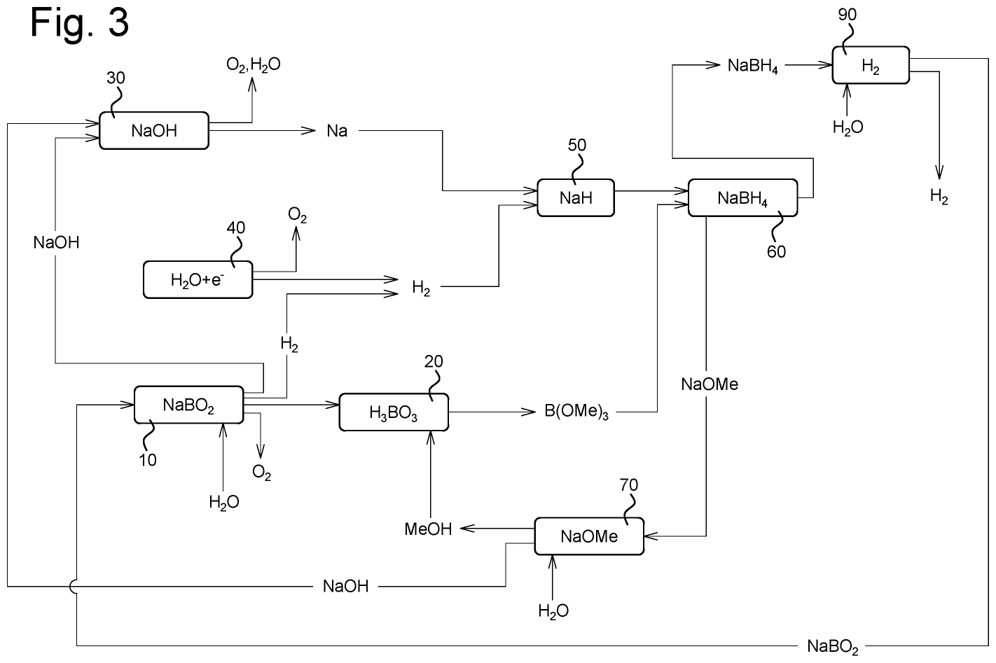

FIG. 3 shows a schematic overview of a circular process for the production of sodium borohydride, NaBH₄, according to an embodiment of the invention, as an example, but the underlying principles are applicable to the production of any metal borohydride, M(BH₄)ₙ. Step 90 of the overview of FIG. 3 actually does not concern a production step for sodium borohydride, but the use of sodium borohydride to yield hydrogen gas, H₂, according to the reaction formula as given in the background of the invention section and reproduced below

NaBH₄+2H₂O→NaBO₂+4H₂,
or for the conversion of a general metal borohydride

M(BH₄)ₙ+2nH₂O→M(BO₂)ₙ+4nH₂.
Instead of using the metal borohydride for the production of hydrogen gas, the metal borohydride can also be used as a reductant. After quenching with, for example, water or any acid, the corresponding metal metaborate will also be obtained.

The byproduct of the conversion of the sodium borohydride to yield hydrogen is sodium metaborate (or generally a metal metaborate, M(BO₂)ₙ). In the example of sodium, generally a hydrate of sodium metaborate, NaBO₂·xH₂O, is the result of the conversion reaction, which may also be referred to as sodium tetrahydroxyborate, NaB(OH)₄. The byproduct sodium metaborate of hydrogen formation in step 90 is used as an input material for the process step 10 in FIG. 3. Process step 10 has been described with reference to FIG. 2, and involves the electrochemical cell 100 for the conversion of sodium metaborate to boric acid, H₃BO₃. The fact that any hydrate of the sodium metaborate may result from hydrogen production step 90 is not of a negative influence on the process in step 10 since the sodium metaborate is dissolved in water and water is a reactant in the process of process step 10 as well.

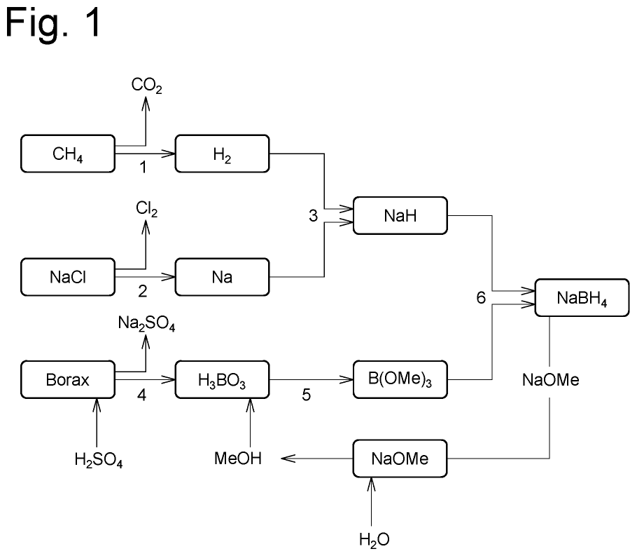

Process step 20 is known from the prior art Brown-Schlesinger process described earlier with respect to FIG. 1, and involves the forming of trimethyl borate, B(OMe)₃ (with Me indicating a methyl group), from the boric acid formed in step 10 through the addition of methanol, MeOH, and the removal of water. To yield sodium borohydride, finally in process step 60, trimethyl borate from step 20 and sodium hydride are reacted. The byproduct sodium methoxide, NaOMe, from step 60 is reacted in a process step 70 with water to recover methanol, which is added again in process step 20, and sodium hydroxide, NaOH, in the embodiment shown.

The overall metal borohydride, M(BH₄)ₙ, production process in the embodiment of FIG. 3 has the boric acid forming step 10 changed with respect to the Brown-Schlesinger process of FIG. 1, but presents some other changes as well. The sodium hydroxide formed in process steps 10 and 70 is used as a sodium source, rather than sodium chloride, NaCl, in a metallic sodium converting process step 30, which can be done through a Castner process with an electrochemical cell, a Castner cell (as disclosed in U.S. Pat. No. 2,461,661 of S. F. Skala and entitled ‘electrolytic anolyte dehydration of castner cells’). The metallic sodium formed in process step 30 is used in process step 50 together with hydrogen formed in process step 10 and/or possibly step 40 to obtain sodium hydride, NaH, to be used in the final sodium borohydride production process step 60, instead of using the hydrogen gas from methane.

With these alterations, various types of waste formation are avoided. The release of the greenhouse gas carbon dioxide, CO₂, in the production of hydrogen, H₂; the formation of toxic chloride gas, Cl₂, in the production of metallic sodium; and the production of sodium sulfate, Na₂SO₄, in the conversion of borax, Na₂B₄O₇, to boric acid, H₃BO₃, which can't be used in any other step of the process. Furthermore, the use of the harsh reactant sulfuric acid, H₂SO₄, needed for step 4 of the original Brown-Schlesinger process, is circumvented. Finally, the need to extract the raw material borax is eliminated. The proposed metal borohydride production process, in combination with the hydrogen generation process from metal borohydride, thus has a high atom economy, generates no waste, is intrinsically more benign, is circular, and the electrochemical processes (i.e. H₂O electrolysis, boric acid production, and the Castner process) can be performed with renewable energy. This makes this new process very sustainable and future-proof.

1. A method of producing metal borohydride, M(BH₄)ₙ, from metal metaborate, M(BO₂)ₙ, or one of its hydrates, M(BO₂)ₙ·xH₂O, as a starting material, in which M is a metal, such as a metallic metal, an alkali metal, an alkaline earth metal, a transition metal or a chemical compound behaving as a metal, n is a valence value of the metal, and x is a number of water molecules associated with the metal metaborate in a respective hydrate, metal borohydride is formed through a reaction of metal hydride, MHₙ, with trimethyl borate, B(OMe)₃, and trimethyl borate is formed through a reaction of boric acid, H₃BO₃, with methanol, MeOH, under removal of water, H₂O,
wherein an electrochemical cell (100) is used for the conversion of metal metaborate and water, H₂O, to boric acid, in the electrochemical cell according to, at least substantially, an overall reaction according to the reaction formula
4M(BO₂)ₙ+10nH₂O→4nH₃BO₃+4M(OH)ₙ+nO₂+2nH₂,
wherein the electrochemical cell has an anodic half-cell (110) with an anode (115) and, at least substantially, water as a liquid in the anodic half-cell, a cathodic half-cell (120) with a cathode (125) and, at least substantially, water as a liquid in the cathodic half-cell, and a cation exchange membrane separating the anodic half-cell and the cathodic half-cell,
wherein a positive pole and a negative pole of an electric potential source are connected to the anode and the cathode, respectively,
wherein, at least substantially, metal metaborate is provided to the water in the anodic half-cell to provide a solution of metal metaborate in water in the anodic half-cell, and, in the anodic half-cell, acid ions, H⁺, and electrons, e⁻, are generated at the anode from electrolysis of water for H⁺ to react with metal metaborate and water, according to the reaction formulas
2nH₂O→4nH⁺+nO₂+4n e⁻, and
4M(BO₂)ₙ+4nH⁺+4nH₂O→4nH₃BO₃+4Mⁿ⁺,
to have, at least substantially, an overall reaction in the anodic half-cell according to the reaction formula
4M(BO₂)ₙ+6nH₂O→4nH₃BO₃+nO₂+4Mⁿ⁺+4n e⁻,
wherein the cation exchange membrane passes metal ions, Mⁿ⁺, from the anodic half-cell to the cathodic half-cell, and
wherein, in the cathodic half-cell, hydroxide ions, OH⁻, are generated at the cathode from water and electrons, e⁻, from the cathode, to form metal hydroxide, M(OH)ₙ, from metal ions and water, according to the reaction formulas
4nH₂O+4n e⁻→2nH₂+4nOH⁻, and
4Mⁿ⁺+4nOH−→4M(OH)ₙ,
to have, at least substantially, an overall reaction in the cathodic half-cell according to the reaction formula
4Mⁿ⁺+4nH₂O+4n e⁻→4M(OH)ₙ+2nH₂.

2. The method according to claim 1, wherein metal hydride is produced from conversion of metal hydroxide in an electrochemical cell to metallic metal and subsequent reaction with hydrogen, H₂.

3. The method according to claim 2, wherein the electrochemical cell is a Castner cell.

4. The method according to claim 2, wherein the hydrogen for the reaction with metallic metal is produced by electrolysis of water.

5. The method according to claim 2, wherein hydrogen produced in the cathodic half-cell of the electrochemical cell for the conversion of metal metaborate and water, H₂O, to boric acid is used for the reaction with metallic metal.

6. A method of producing boric acid, H₃BO₃, from metal metaborate, M(BO₂)ₙ, or one of its hydrates, M(BO₂)ₙ·xH₂O, as a starting material, in which M is a metal, such as a metallic metal, an alkali metal, an alkaline earth metal, or a transition metal, or a chemical compound acting as a metal, n is a valence value of the metal, and x is a number of water molecules associated with the metal metaborate in a respective hydrate,
wherein an electrochemical cell (100) is used for the conversion of metal metaborate and water, H₂O, to boric acid, in the electrochemical cell according to, at least substantially, an overall reaction according to the reaction formula
4M(BO₂)ₙ+10nH₂O→4nH₃BO₃+4M(OH)ₙ+nO₂+2nH₂,
wherein the electrochemical cell has an anodic half-cell (110) with an anode (115) and, at least substantially, water as a liquid in the anodic half-cell, a cathodic half-cell (120) with a cathode (125) and, at least substantially, only water as a liquid in the cathodic half-cell, and a cation exchange membrane separating the anodic half-cell and the cathodic half-cell, wherein a positive pole and a negative pole of an electric potential source are connected to the anode and the cathode, respectively,
wherein, at least substantially, metal metaborate is provided to the water in the anodic half-cell to provide a solution of metal metaborate in water in the anodic half-cell, and, in the anodic half-cell, acid ions, H⁺, and electrons, e⁻, are generated at the anode from electrolysis of water for H⁺ to react with metal metaborate and water, according to the reaction formulas
2nH₂O→4nH⁺+nO₂+4n e⁻, and
4M(BO₂)ₙ+4nH⁺+4nH₂O→4nH₃BO₃+4Mⁿ⁺,
to have, at least substantially, an overall reaction in the anodic half-cell according to the reaction formula
4M(BO₂)ₙ+6nH₂O→4nH₃BO₃+nO₂+4 Mⁿ⁺+4n e⁻,
wherein the cation exchange membrane passes metal ions, Mⁿ⁺, from the anodic half-cell to the cathodic half-cell, and
wherein, in the cathodic half-cell, hydroxide ions, OH⁻, are generated at the cathode from water and electrons, e⁻, from the cathode, to form metal hydroxide, M(OH)ₙ, from metal ions and water, according to the reaction formulas
4nH₂O+4n e⁻→2nH₂+4nOH⁻, and
4Mⁿ⁺+4nOH⁻→4M(OH)ₙ,
to have, at least substantially, an overall reaction in the cathodic half-cell according to the reaction formula
4Mⁿ⁺+4nH₂O+4n e⁻→4M(OH)ₙ+2nH₂.

7. The method according to claim 1, wherein the metal, M, is selected from at least one of lithium, Li; sodium, Na; potassium, K; magnesium, Mg; calcium, Ca; and aluminum, Al.

8. The method according to claim 1, wherein the concentration of metal metaborate in water is in the range of 0.2 M to 8 M.

9. The method according to claim 1, wherein metal hydroxide is added to the cathodic half-cell for enhanced electrical conductivity.

10. The method according to the claim 1, wherein the concentration of metal hydroxide in water is in the range of 0 M to 3 M.

11. The method according to claim 1, wherein the electric potential source is provided by a potentiostat, galvanostat or battery.

12. The method according to claim 1, wherein an electric potential provided by the electric potential source between the anode and the cathode is in the range of 2V to 12V.

13. The method according to claim 1, wherein a material of the anode is selected from at least one of stainless steel, mild steel, nickel, Raney Nickel or Raney Nickel contaminated with small amounts of other metals.

14. The method according to claim 1, wherein a material of the cathode is selected from at least one of DSA platinized titanium and any other type of platinum-based material.

15. The method according to claim 1, wherein the electrochemical cell for the conversion of metal metaborate and water, H₂O, to boric acid is an electrochemical flow cell or a batch electrochemical cell.

16. The method according to claim 1, wherein the boric acid provided by the electrochemical cell is available as a solution of boric acid dissolved in water, and the solution of boric acid dissolved in water is at least one of cooled and concentrated to obtain boric acid by precipitation.
